(19) United States
(12) Patent Application Publication
(10) Pub. No.: US 2026/0171433 A1
(43) Pub. Date: Jun. 18, 2026

(54) INSULATOR

(71) Applicant: HONDA MOTOR CO., LTD., Tokyo (JP)

(72) Inventors: Naoki TANAKA, Saitama (JP); Kenji SASAKI, Saitama (JP)

(21) Appl. No.: 19/415,817

(22) Filed: Dec. 11, 2025

(30) Foreign Application Priority Data
Dec. 13, 2024 (JP) 2024-219452

(51) Int. Cl. H01M 8/0247; H01M 8/10; H01M 8/1004; H01M 8/241

(52) U.S. Cl. CPC H01M 8/0247; H01M 8/1004; H01M 8/241; H01M 2008/1095

(57) ABSTRACT

An insulator capable of improving manufacturability and rigidity is provided. An insulator is provided in a fuel cell stack. The fuel cell stack includes: a cell stack body formed by stacking a plurality of power generation cells, each including an electrolyte membrane-electrode assembly and separators and; a terminal plate provided at an end of the cell stack body in the stacking direction; the insulator; and an end plate. The terminal plate, the insulator, and the end plate are provided in this order from the cell stack body side in the stacking direction. The insulator includes: a main body; a first rib standing from a first surface of the main body, the first surface facing the terminal plate; and a second rib standing from a second surface of the main body, the second surface facing the end plate.

This application is based on and claims the benefit of priority from Japanese application No. 2024-219452 filed on Dec. 13, 2024, the content of which is incorporated herein by reference.

### BACKGROUND OF THE INVENTION

### Field of the Invention

The present invention relates to an insulator.

### Related Art

Conventionally, research and development have been conducted on fuel cell stacks that contribute to energy efficiency to ensure access to sustainable and advanced energy. Known examples of a fuel cell stack include a cell stack body formed by stacking a plurality of power generation cells, each including an electrolyte membrane-electrode assembly and a separator. A terminal plate, an insulator, and an end plate are sequentially provided outward in this order at an end portion of the cell stack body in a stacking direction.

A technique has been proposed, in which ribs are formed on the insulator to improve sealing performance and heat insulation of the fuel cell stack (see, for example, Patent Document 1).

Patent Document 1: Japanese Unexamined Patent Application, Publication No. 2020-126804

### SUMMARY OF THE INVENTION

When the ribs are formed on the insulator, there has been a concern that the ribs may not be molded into a desired shape, resulting in reduced yield and manufacturability. Therefore, there is a demand for achieving successful rib formation with high probability. Solving this issue leads to improvements in the manufacturability, rigidity, and heat insulation of the fuel cell stack, thereby contributing to energy efficiency.

(1) The present invention provides an insulator (e.g., an insulator 16) provided in a fuel cell stack (e.g., a fuel cell stack 1), in which the fuel cell stack includes: a cell stack body (e.g., a cell stack body 10) formed by stacking a plurality of power generation cells (e.g., power generation cells 12), each including an electrolyte membrane-electrode assembly (e.g., an electrolyte membrane-electrode assembly 20) and a separator (e.g., a first metal separator 24 and a second metal separator 26); a terminal plate (e.g., a terminal plate 15) provided at an end portion of the cell stack body in the stacking direction; the insulator; and an end plate (e.g., an end plate 17), in which the terminal plate, the insulator, and the end plate are provided in this order from the cell stack body side in the stacking direction. The insulator includes a main body (e.g., a main body 60), a first rib (e.g., a first rib 61) standing from a first surface (e.g., a first surface 6a) of the main body, the first surface facing the terminal plate, and a second rib (e.g., a second rib 62) standing from a second surface (e.g., a second surface 6b) of the main body, the second surface facing the end plate.

(2) It is preferable that the first rib and the second rib be configured with a single member.

(3) It is preferable that the first rib and the second rib have the same shape, as viewed in the stacking direction.

(4) It is preferable that the first rib and the second rib be arranged at the same position, as viewed in the stacking direction.

(5) It is preferable that a third rib (e.g., a third rib 73) stand from the surface of the end plate, the surface facing the insulator so as to abut the second rib.

(6) It is preferable that the second rib and the third rib have the same shape, as viewed in the stacking direction.

(7) It is preferable that the second rib and the third rib be arranged at the same position, as viewed in the stacking direction.

According to the aspect (1), when ribs are formed on both surfaces of the main body, the heights of the first rib and the second rib are halved compared with a case where a rib is formed only on one side of the insulator. Therefore, even when the thickness of the insulator in the stacking direction remains the same, the first rib and the second rib formed on the first surface and the second surface, respectively, are lower in height than a rib formed on only one surface. When ribs are formed by injection molding, in a case where a long rib is formed on only one surface of the insulator, resin may not entirely fill the concave portion of a molding die. However, when the first rib and the second rib are formed from the first surface and the second surface of the main body, respectively, the depth of the concave portion of the molding die becomes shallower, allowing the resin to fill to the end of the concave portion, thereby improving manufacturability. In a fuel cell stack, a load is applied when stacking the cell stack body, the terminal plate, the insulator, and the end plate. At this time, the first rib and the second rib need to have sufficient rigidity to withstand the surface pressure applied. By providing the first rib and the second rib on both surfaces of the main body, the ribs become lower in height than the case of the ribs formed only on one side, thereby improving the rigidity of the insulator. In addition, two air layers are formed between the first rib and the second rib, thereby improving heat insulation.

According to the aspect (2), the insulator can be manufactured with a single molding die, thereby simplifying the manufacturing process and improving manufacturability.

There is no misalignment between the first rib and the second rib, thereby achieving stable rigidity.

According to the aspect (3), the shape is less likely to cause molding defects, thereby improving manufacturability.

According to the aspect (4), the shape is less likely to cause molding defects, thereby improving manufacturability and enhancing rigidity.

According to the aspect (5), by bringing the second rib and the third rib into abutment with each other, an air layer is formed between the second rib and the third rib, thereby improving heat insulation, and securing sufficient rigidity and surface pressure even when the third rib is provided on the end plate.

According to the aspect (6), it is possible to maximize the surface pressure when the third rib is provided on the end plate.

According to the aspect (7), it is possible to maximize the surface pressure when the third rib is provided on the end plate.

### BRIEF DESCRIPTION OF THE DRAWINGS

FIG. 1 is a schematic diagram illustrating a fuel cell stack according to the present embodiment;

FIG. 2 is a schematic diagram illustrating a power generation cell according to the present embodiment;

FIG. 3A is a plan view illustrating an insulator according to the present embodiment, as viewed from a first surface;

FIG. 3B is a plan view illustrating the insulator according to the present embodiment, as viewed from a second surface;

FIG. 3C is an enlarged cross-sectional view taken along the line A-A in FIG. 3B;

FIG. 4 is a plan view illustrating an end plate according to the present embodiment, as viewed from the surface facing the insulator;

FIG. 5A is a plan view illustrating a state where the insulator is overlapped on the end plate according to the present embodiment;

FIG. 5B is a schematic cross-sectional view taken along the line C-C in FIG. 5A; and

FIG. 5C is a schematic cross-sectional view taken along the line B-B in FIG. 5A.

### DETAILED DESCRIPTION OF THE INVENTION

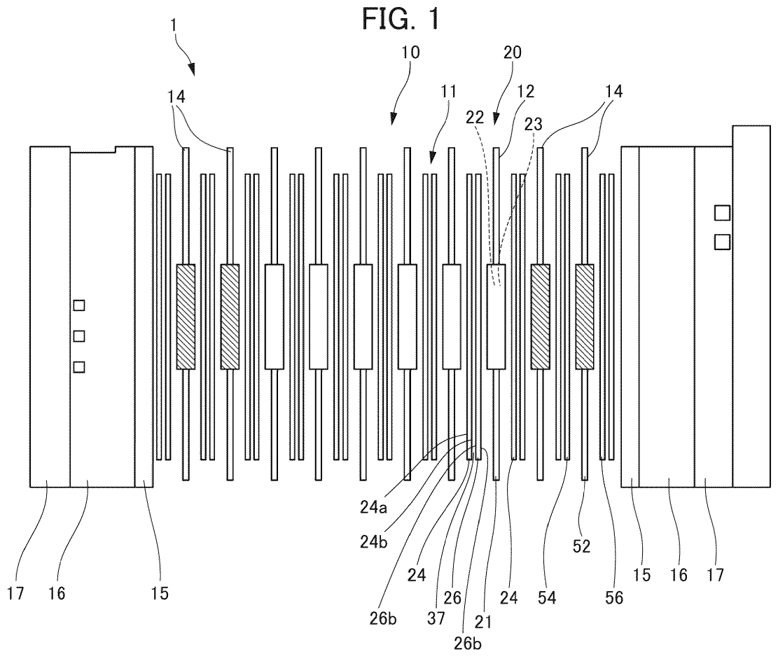

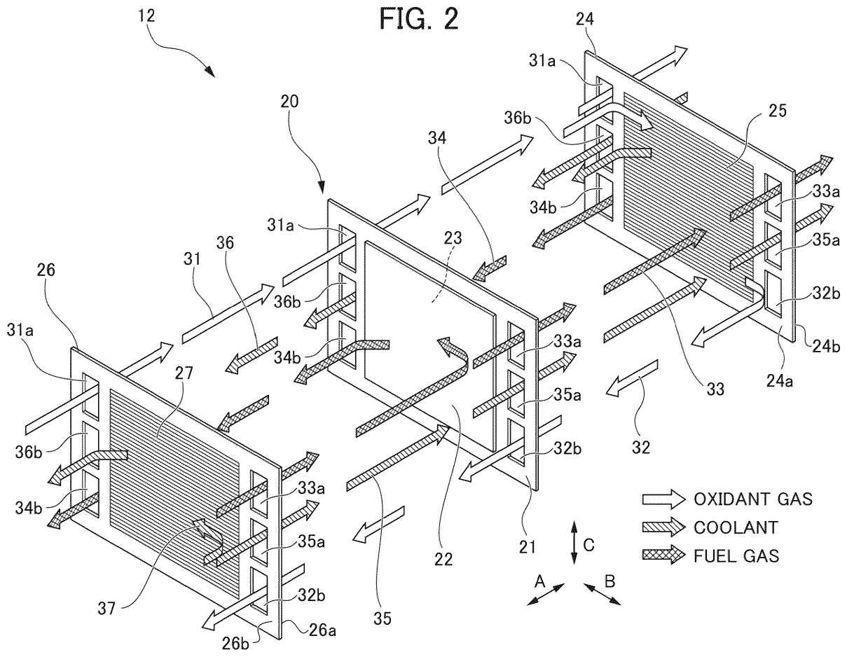

Hereinafter, an embodiment of the present disclosure will be described in detail with reference to the drawings. FIG. 1 is a diagram schematically illustrating a configuration of a fuel cell stack 1, in which an insulator 16 according to the present embodiment is provided. As illustrated in FIG. 1, the fuel cell stack 1 includes: a cell stack body 10 configured by stacking a plurality of cells 11; a terminal plate 15 provided at an end of the cell stack body 10 in the stacking direction; the insulator 16; and an end plate 17. The terminal plate 15, the insulator 16, and the end plate 17 are arranged in this order from the cell stack body 10 side toward the outer side. The stacking direction in the present specification refers to a direction of stacking the cells 11 constituting the cell stack body 10, the terminal plate 15, the insulator 16, and the end plate 17; and the stacking direction corresponds to the arrow A direction in FIG. 2.

First, a configuration of the cell stack body 10 side will be described. As schematically illustrated in FIG. 2, the fuel cell stack 1 is configured such that an oxidant gas, a fuel gas, and a coolant can flow inside and outside of each cell 11. The fuel cell stack 1 includes an oxidant gas supply flow path 31, an oxidant off-gas flow path 32, a fuel gas supply flow path 33, a fuel off-gas flow path 34, a coolant supply flow path 35, and a coolant discharge path 36.

Each cell 11 includes a power generation cell 12 and a dummy cell 14. The cell stack body 10 is configured by stacking the plurality of power generation cells 12 and the plurality of dummy cells 14. FIG. 2 is a diagram explaining a configuration of the power generation cell 12. As illustrated in FIG. 2, the power generation cell 12 includes: an electrolyte membrane-electrode assembly 20; and a first metal separator 24 and a second metal separator 26, both serving as separators sandwiching the electrolyte membrane-electrode assembly 20. Although not illustrated, sealing members such as gaskets are interposed between the electrolyte membrane-electrode assembly 20 and the first and second metal separators 24 and 26, so as to surround various communication holes and outer peripheries of electrode surfaces described later (power generation surfaces).

An oxidant gas supply communication hole 31a for supplying an oxidant gas, e.g., oxygen-containing gas; a coolant discharge communication hole 36b for discharging a coolant; and a fuel gas discharge communication hole 34b for discharging a fuel gas, e.g., hydrogen-containing gas, are arranged in the arrow C direction (vertical direction) at one end portion of the power generation cell 12 in the arrow B direction, and are in communication with each other in the arrow A direction (stacking direction).

A fuel gas supply communication hole 33a for supplying a fuel gas; a coolant supply communication hole 35a for supplying a coolant; and an oxidant gas discharge communication hole 32b for discharging an oxidant gas, are arranged in the arrow C direction, at the other end portion of the power generation cell 12 in the arrow B direction, and are in communication with each other in the arrow A direction.

The oxidant gas supply communication holes 31a formed in the respective power generation cells 12 form the oxidant gas supply flow path 31 for supplying oxidant gas to the power generation cells 12, in a state where the plurality of power generation cells 12 are stacked in an aligned manner as illustrated in FIG. 1. The oxidant gas discharge communication hole 32b forms the oxidant off-gas flow path 32 through which oxidant gas discharged from the power generation cells 12 flows, in a state where the plurality of power generation cells 12 are stacked in an aligned manner.

The fuel gas supply communication holes 33a formed in the respective power generation cells 12 form the fuel gas supply flow path 33 for supplying fuel gas to the power generation cells 12, in a state where the plurality of power generation cells 12 are stacked in an aligned manner. The fuel gas discharge communication holes 34b form the fuel off-gas flow path 34, through which the fuel off-gas discharged from the power generation cells 12 flows, in a state where the plurality of power generation cells 12 are stacked in an aligned manner.

The coolant supply communication holes 35a formed in the respective power generation cells 12 form the coolant supply flow path 35 for supplying the coolant to the first metal separator 24 and the second metal separator 26 described later, in a state where the plurality of power generation cells 12 are stacked in an aligned manner. The coolant discharge communication holes 36b form the coolant discharge path 36, through which the coolant discharged from the first metal separator 24 and the second metal separator 26 flows.

The electrolyte membrane-electrode assembly 20 includes, for example: a solid polymer electrolyte membrane 21 composed of a thin film of perfluorosulfonic acid impregnated with water; and an anode electrode 22 and a cathode electrode 23 sandwiching the solid polymer electrolyte membrane 21 (see FIGS. 1 and 2).

The anode electrode 22 and the cathode electrode 23 each include: a gas diffusion layer made of, for example, carbon paper; and an electrode catalyst layer formed by uniformly applying porous carbon particles carrying a platinum alloy on the surface of the gas diffusion layer. The electrode catalyst layers are bonded to both surfaces of the solid polymer electrolyte membrane 21, so as to face each other with the solid polymer electrolyte membrane 21 interposed therebetween.

The first metal separator 24 and the second metal separator 26 are formed of, for example, metal or carbon, and are arranged to sandwich the electrolyte membrane-electrode assembly 20.

As illustrated in FIG. 2, an oxidant gas flow groove portion 25, which communicates with the oxidant gas supply communication hole 31a and the oxidant gas discharge communication hole 32b, is provided on the surface 24a of the first metal separator 24 facing the electrolyte membrane-electrode assembly 20. The oxidant gas flow groove portion 25 is formed such that a plurality of grooves extending in the arrow B direction are formed on the surface 24a of the first metal separator 24, and the oxidant gas flows between the grooves and the cathode electrode 23. The oxidant gas supplied from the oxidant gas supply flow path 31 flows through the oxidant gas flow groove portion 25 in the arrow B direction, and is discharged into the oxidant off-gas flow path 32.

A fuel gas flow groove portion 27, which communicates with the fuel gas supply communication hole 33a and the fuel gas discharge communication hole 34b, is formed on the surface 26a of the second metal separator 26 facing the electrolyte membrane-electrode assembly 20. The fuel gas flow groove portion 27 is formed such that a plurality of grooves extending in the arrow B direction are formed on the surface 26a of the second metal separator 26, and the fuel gas flows between the grooves and the anode electrode 22. The fuel gas supplied from the fuel gas supply flow path 33 flows through the fuel gas flow groove portion 27 in the arrow B direction, and is discharged into the fuel off-gas flow path 34.

In a state where the plurality of power generation cells 12 are stacked as illustrated in FIG. 1, a coolant flow groove portion 37, which communicates with the coolant supply communication hole 35a and the coolant discharge communication hole 36b, is formed between the surface 24b of the first metal separator 24 and the surface 26b of the second metal separator 26, the faces being adjacent to each other. The coolant flow groove portion 37 is integrally configured to extend in the arrow B direction by overlapping a plurality of grooves provided in the first metal separator 24 with a plurality of grooves provided in the second metal separator 26. The coolant supplied from the coolant supply flow path 35 flows through the coolant flow groove portion 37 in the arrow B direction, and is discharged into the coolant discharge path 36.

As illustrated in FIG. 1, the dummy cell 14 includes a conductive plate 52 corresponding to the electrolyte membrane-electrode assembly 20, and a dummy-cell first metal separator 54 and a dummy-cell second metal separator 56 sandwiching the conductive plate 52. The conductive plate 52 is, for example, formed of a metal plate and has substantially the same configuration as the electrolyte membrane-electrode assembly 20. However, the dummy cell 14 does not include the electrolyte membrane-electrode assembly 20 and does not generate product water resulting from power generation.

The dummy-cell first metal separator 54 and the dummy-cell second metal separator 56 each include an oxidant gas supply communication hole 31a, a coolant discharge communication hole 36b, a fuel gas discharge communication hole 34b, a fuel gas supply communication hole 33a, a coolant supply communication hole 35a, and an oxidant gas discharge communication hole 32b. The oxidant gas supply communication hole 31a, the coolant discharge communication hole 36b, and the fuel gas discharge communication hole 34b are arranged in the arrow C direction (vertical direction), at one end portion of the dummy-cell first metal separator 54 and the dummy-cell second metal separator 56 in the arrow B direction. The fuel gas supply communication hole 33a, the coolant supply communication hole 35a, and the oxidant gas discharge communication hole 32b are arranged in the arrow C direction, at the other end portion of the dummy-cell first metal separator 54 and the dummy-cell second metal separator 56 in the arrow B direction. The dummy cell 14 allows water vapor flowing into the oxidant gas supply flow path 31 to flow through the plurality of grooves extending in the arrow B direction and provided in the dummy-cell first metal separator 54 and the dummy-cell second metal separator 56, thereby preventing excessive water vapor from flowing into the power generation cell 12.

The cell stack body 10 described above is supplied with a fuel gas such as a hydrogen-containing gas, an oxidant gas such as air or other oxygen-containing gas, and a coolant such as pure water, ethylene glycol, or oil.

As illustrated in FIG. 2, in each power generation cell 12, the fuel gas is introduced from the fuel gas supply communication hole 33a into the fuel gas flow groove portion 27 of the second metal separator 26, and moves along the anode electrode 22 that constitutes the electrolyte membrane-electrode assembly 20. The oxidant gas is introduced from the oxidant gas supply communication hole 31a into the oxidant gas flow groove portion 25 of the first metal separator 24, and moves along the cathode electrode 23 that constitutes the electrolyte membrane-electrode assembly 20.

In the electrolyte membrane-electrode assembly 20, the fuel gas supplied to the anode electrode 22 and the oxidant gas supplied to the cathode electrode 23 are consumed in the electrode catalyst layers by electrochemical reactions, thereby generating electricity. In the catalyst layer of the anode electrode 22, electrons are extracted from hydrogen in the fuel gas to produce hydrogen ions, which are conducted through the electrolyte membrane to the cathode side. Then, in the catalyst layer of the cathode electrode 23, the hydrogen ions react with oxygen in the oxidant gas to produce product water. In this manner, product water is generated on the cathode side. A portion of the generated product water migrates through the electrolyte membrane to the anode side.

The oxidant gas supplied to and consumed at the cathode electrode 23 is discharged in the arrow A direction through the oxidant gas discharge communication hole 32b. The fuel gas supplied to and consumed at the anode electrode 22 is discharged in the arrow A direction through the fuel gas discharge communication hole 34b.

The coolant supplied to the coolant supply communication hole 35a is introduced into the coolant flow groove portion 37 between the first metal separator 24 and the second metal separator 26, and flows in the arrow B direction. The coolant cools the electrolyte membrane-electrode assembly 20, and is subsequently discharged from the coolant discharge communication hole 36b.

The oxidant gas supply communication hole 31a, the coolant discharge communication hole 36b, and the fuel gas discharge communication hole 34b are arranged in the arrow C direction (vertical direction), at one end portion of the terminal plate 15, the insulator 16, and the end plate 17 in the arrow B direction. The fuel gas supply communication hole 33a, the coolant supply communication hole 35a, and the oxidant gas discharge communication hole 32b are arranged in the arrow C direction, at the other end portion in the arrow B direction. That is, the flow paths formed in the cell stack body 10 (including the oxidant gas supply flow path 31, the oxidant off-gas flow path 32, the fuel gas supply flow path 33, the fuel off-gas flow path 34, the coolant supply flow path 35, and the coolant discharge path 36) are also formed in the terminal plate 15, the insulator 16, and the end plate 17, such that each gas can flow therethrough. FIG. 1 is a schematic diagram illustrating the fuel cell stack 1 as viewed from the side, thus does not illustrate these flow paths.

The terminal plate 15 is arranged at both ends of the cell stack body 10, thereby sandwiching the cell stack body 10. The terminal plate 15 is formed of an electrically conductive material. The terminal plate 15 is, for example, a substantially rectangular plate-shaped member made of metal, and includes a terminal portion for extracting electric power generated in the cell stack body 10 by electrochemical reactions.

The insulator 16 is arranged outward from the terminal plate 15 in the stacking direction, and is arranged adjacent to the terminal plate 15. The insulator 16 is formed of an insulating material such as polycarbonate or phenolic resin, and is formed to be thicker than the terminal plate 15 in the stacking direction, as illustrated in FIG. 1. The insulator 16 electrically insulates the terminal plate 15 from the end plate 17, described below.

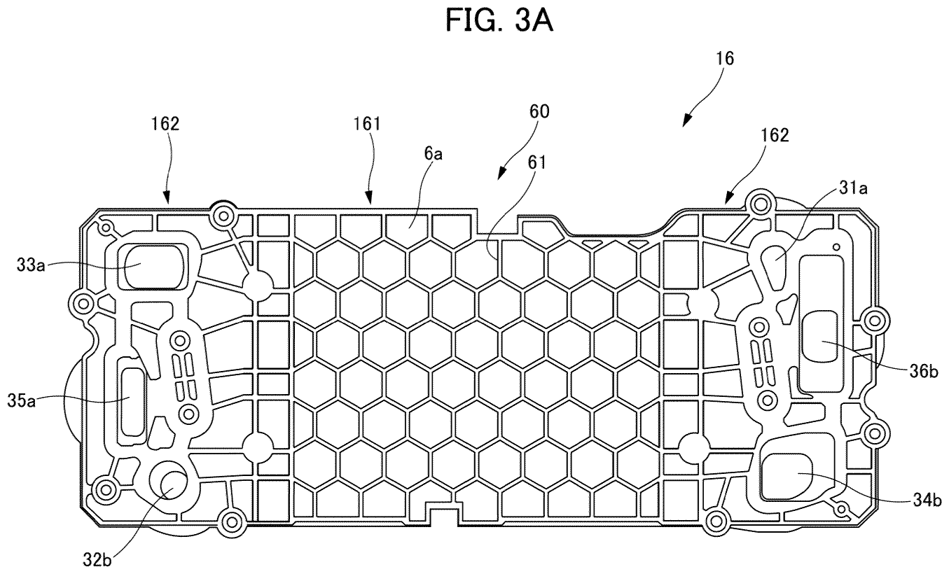

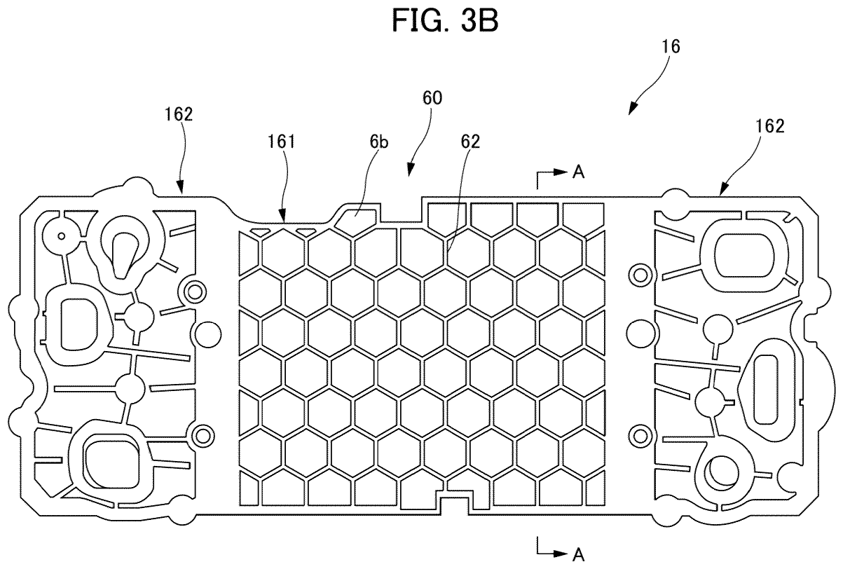

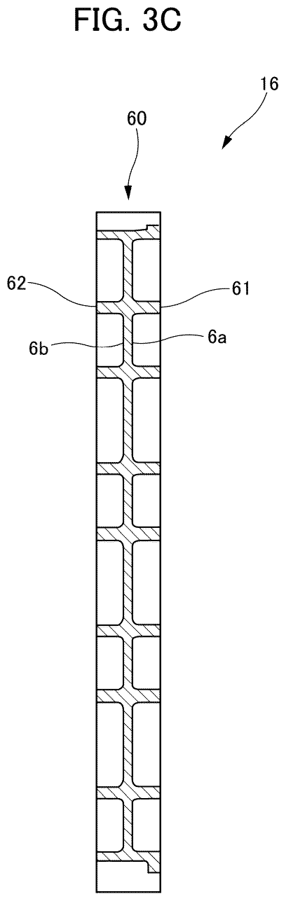

As illustrated in FIGS. 3A to 3C, the insulator 16 is formed with ribs standing toward both the terminal plate 15 and the end plate 17. Specifically, the insulator 16 includes a main body 60, a first surface 6a, a second surface 6b, a first rib 61, and a second rib 62.

As illustrated in FIGS. 3A and 3B, the main body 60 has a generally rectangular plate-like shape, as viewed from the stacking direction, and is arranged so as to be sandwiched between the terminal plate 15 and the end plate 17. The main body 60 includes a flow path peripheral region 162 and a rib formation region 161. The flow path peripheral region 162 is a region where the holes for the gas flow paths are formed in the main body 60, and is arranged at one and the other end of the main body 60 in the longitudinal direction. The rib formation region 161 is a substantially rectangular region arranged in a central portion of the main body 60 in the longitudinal direction, as sandwiched between the pair of flow path peripheral regions 162.

The first surface 6a is the surface of the main body 60, facing the terminal plate 15. The second surface 6b is the surface of the main body 60, facing the end plate 17.

The first rib 61 stands from the first surface 6a of the rib formation region 161, and stands upright toward the terminal plate 15, as illustrated in FIG. 3C. As illustrated in FIG. 3A, the first rib 61 is arranged within the rib formation region 161 such that hexagonal shapes are continuously formed, thereby forming a substantially honeycomb shape in a plan view, as viewed from the stacking direction.

The second rib 62 stands from the second surface 6b of the rib formation region 161, and stands upright toward the end plate 17, as illustrated in FIG. 3C. As illustrated in FIG. 3B, the second rib 62 is arranged within the rib formation region 161 such that hexagonal shapes are continuously formed, thereby forming a substantially honeycomb shape in a plan view, as viewed from the stacking direction.

The second rib 62 and the first rib 61 are formed as a single member, and are continuously formed from the main body 60. For example, the second rib 62 and the first rib 61 are formed by resin injection molding. The second rib 62 and the first rib 61 have the same shape as viewed from the stacking direction, and are arranged at the same position with the main body 60 interposed therebetween as viewed from the stacking direction. The height from the second surface 6b of the main body 60 to the second rib 62 and the height from the first surface 6a of the main body 60 to the first rib 61 are the same. The total thickness of the main body 60, the first rib 61, and the second rib 62 in the stacking direction constitutes the insulation distance ensured by the insulator 16.

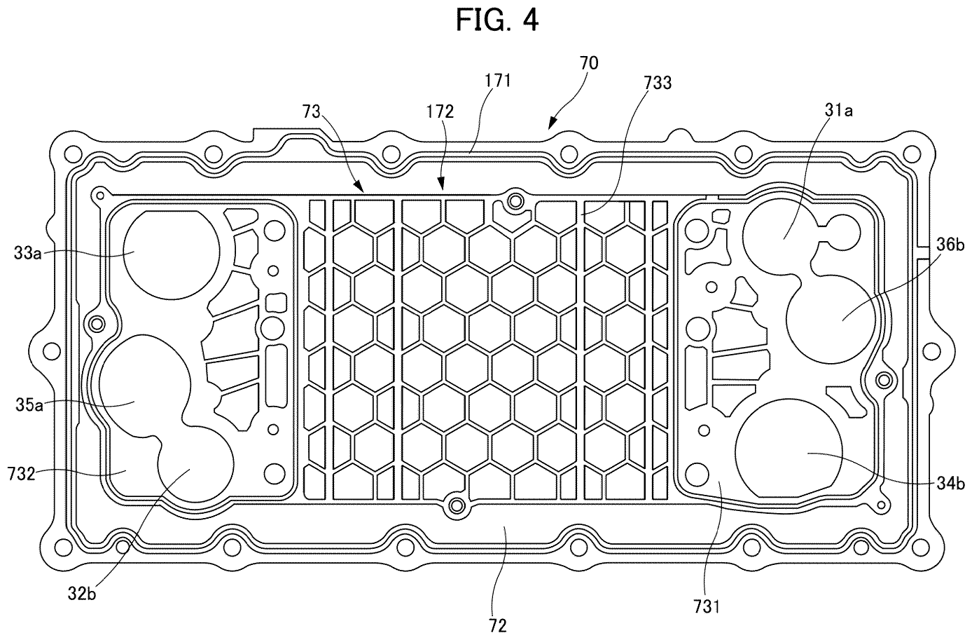

The end plate 17 is arranged outward from the insulator 16 in the stacking direction, and is arranged adjacent to the insulator 16. The end plate 17 is arranged at the outermost side of the fuel cell stack 1, and is connected to a case (not illustrated) that houses the cell stack body 10. The end plate has a substantially rectangular shape larger in outer dimensions than the insulator 16. As illustrated in FIG. 4, the end plate 17 includes an end plate main body portion 70, flow path peripheral ribs 731 and 732, a reinforcing rib 733, a third rib 73, and a main body recess 72.

The end plate main body portion 70 has a substantially plate-like shape. The end plate main body portion 70 includes an outer edge portion 171 and a rib formation region 172. The outer edge portion 171 is arranged along the four edges of the end plate main body portion 70, and includes screw holes or the like for attachment to a case (not illustrated) that houses the fuel cell stack 1. The rib formation region 172 is a substantially rectangular region arranged inside the outer edge portion 171, and smaller in size than the end plate main body portion 70 itself.

As illustrated in FIG. 4, the flow path peripheral ribs 731 and 732 are arranged at one and the other end of the rib formation region 172 in the longitudinal direction. The flow path peripheral ribs 731 and 732 are formed in peripheral regions around the holes of the gas flow paths formed in the end plate main body portion 70. Specifically, the flow path peripheral rib 731 is formed so as to surround the oxidant gas supply communication hole 31a, the coolant discharge communication hole 36b, and the fuel gas discharge communication hole 34b, which are formed on one side of the end plate main body portion 70. The flow path peripheral rib 732 is formed so as to surround the fuel gas supply communication hole 33a, the coolant supply communication hole 35a, and the oxidant gas discharge communication hole 32b. The flow path peripheral ribs 731 and 732 stand from the end plate main body portion 70 and include continuous surrounding surfaces in a plan view. The reinforcing ribs 733 are formed to extend linearly in the lateral direction of the rib formation region 172 so as to connect and reinforce the honeycomb-shaped third rib 73 described later. The plurality of reinforcing ribs 733 are arranged at one and the other end of the rib formation region 172.

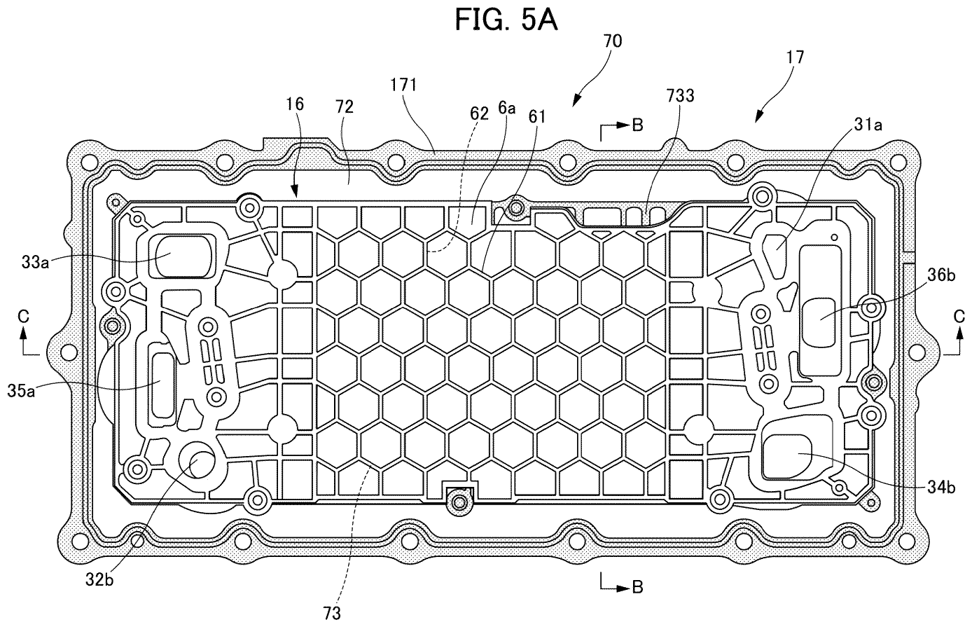

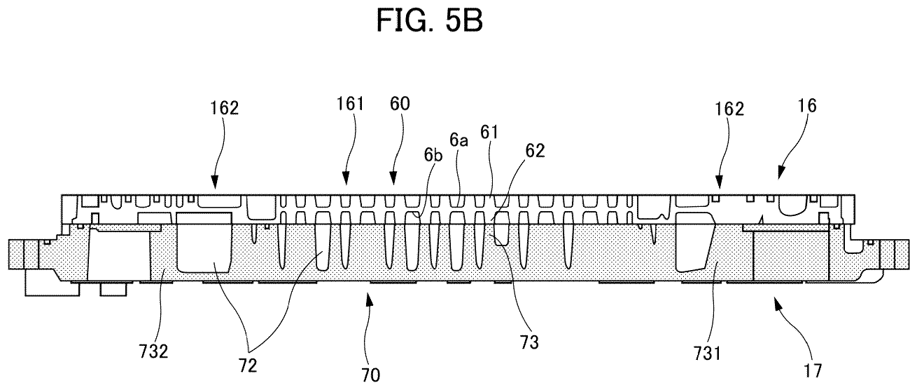

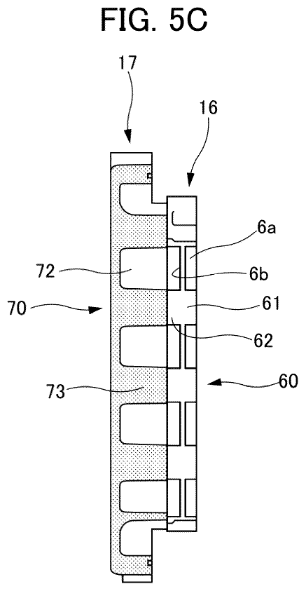

The third rib 73 is formed between the flow path peripheral ribs 731 and 732 at one and the other end of the end plate main body portion 70. FIGS. 5A to 5C illustrate a state where the insulator 16 is arranged on the inner side surface of the end plate 17. For convenience of description, the outer edge portion 171, the flow path peripheral ribs 731 and 732, the third rib 73, and the reinforcing ribs 733 of the end plate 17 are illustrated in gray so as to be distinguished from the insulator 16. As illustrated in FIGS. 5B and 5C, the third rib 73 is arranged such that the end surface of the third rib 73 abuts the end surface of the second rib 62 of the insulator 16. The third rib 73 has a honeycomb shape that is the same as that of the first rib 61 and the second rib 62 as viewed from the stacking direction, and is arranged at the same position overlapping with the first rib 61 and the second rib 62 as viewed from the stacking direction. As illustrated in FIG. 5C, the third rib 73, the first rib 61, and the second rib 62 are continuous in the stacking direction in a cross-sectional view, as viewed from the side.

The main body recess 72 refers to a recessed portion between the outer edge portion 171 and the third rib 73, and between the adjacent third ribs 73, in the end plate main body portion 70. By the presence of the main body recess 72, an air layer is formed between the end plate main body portion 70 and the insulator 16.

According to the present embodiment, the following advantageous effects can be achieved.

(1) The insulator 16 is provided in the fuel cell stack 1. The fuel cell stack 1 is configured to include: the cell stack body 10 formed by stacking the plurality of power generation cells 12, each including the electrolyte membrane-electrode assembly 20 and the separators (the first metal separator 24 and the second metal separator 26); the terminal plate 15 provided at the end of the cell stack body 10 in the stacking direction; the insulator 16; and the end plate 17. The terminal plate 15, the insulator 16, and the end plate 17 are arranged in this order from the cell stack body 10 side in the stacking direction. The insulator 16 is configured to include the main body 60, the first rib 61 standing from the first surface 6a of the main body 60 facing the terminal plate 15, and the second rib 62 standing from the second surface 6b of the main body 60 facing the end plate 17.

When ribs are formed on both surfaces of the main body 60, the height of each of the first rib 61 and the second rib 62 becomes half that of a case where ribs are formed on only one surface of the insulator 16. Therefore, even when the thickness of the insulator 16 in the stacking direction remains the same, the case of providing the first rib 61 and the second rib 62 on the first surface 6a and the second surface 6b, respectively, results in a lower height for each rib compared to the case of forming the ribs on only one surface. In a case where long ribs are formed on only one surface of the insulator when forming the ribs by injection molding, resin may not entirely fill the concave portions of a molding die. However, when the first rib 61 and the second rib 62 are formed from the first surface 6a and the second surface 6b of the main body 60, respectively, the depth of the concave portions of the molding die becomes shallow, allowing the resin to fill to the end, thereby improving manufacturability. In the fuel cell stack 1, a load is applied when stacking the cell stack body 10, the terminal plate 15, the insulator 16, and the end plate 17. At this time, the first rib 61 and the second rib 62 need to have sufficient rigidity to withstand the surface pressure applied. By providing the first rib 61 and the second rib 62 on both surfaces of the main body 60, the rib height becomes lower than a case where ribs are formed on only one surface, thereby improving the rigidity of the insulator 16. In addition, by forming two air layers between the first rib 61 and the second rib 62, heat insulation is also improved.

(2) The first rib 61 and the second rib 62 are formed as a single member. As a result, the insulator 16 can be manufactured with a single molding die, simplifying the manufacturing process and improving manufacturability. There is no misalignment between the first rib 61 and the second rib 62, thereby achieving stable rigidity.

(3) The first rib 61 and the second rib 62 are formed to have the same shape, as viewed from the stacking direction. As a result, the shape is less likely to cause molding defects, thereby improving manufacturability.

(4) The first rib 61 and the second rib 62 are arranged at the same position, as viewed from the stacking direction. As a result, the shape is less likely to cause molding defects, thereby improving manufacturability and increasing rigidity.

(5) The third rib 73 is provided on the surface of the end plate 17 facing the insulator 16, so as to abut the second rib 62. By bringing the second rib 62 and the third rib 73 into abutment with each other, an air layer is formed between the second rib 62 and the third rib 73 to improve heat insulation, and sufficient rigidity and surface pressure can be ensured even when the third rib 73 is provided on the end plate 17.

(6) The second rib 62 and the third rib 73 are formed to have the same shape, as viewed from the stacking direction. As a result, it is possible to ensure the maximum surface pressure when the third rib 73 is provided on the end plate 17.

(7) The second rib 62 and the third rib 73 are arranged at the same position, as viewed from the stacking direction. As a result, it is possible to ensure the maximum surface pressure when the third rib 73 is provided on the end plate 17.

It should be noted that the present invention is not limited to the above embodiment, and modifications and improvements within the scope of achieving the object of the present invention are included in the present invention. For example, although the example of the first rib 61 and the second rib 62 each having a honeycomb shape has been described, the shape is not limited thereto. The first rib 61 and the second rib 62 may have a lattice shape, or may be circular, triangular, rhombic, or any other shape that enhances rigidity.

### EXPLANATION OF REFERENCE NUMERALS

1: fuel cell stack

6a: first surface

6b: second surface

10: cell stack body

12: power generation cell

15: terminal plate

16: insulator

17: end plate

20: electrolyte membrane-electrode assembly

24: first metal separator (separator)

26: second metal separator (separator)

60: main body

61: first rib

62: second rib

73: third rib

What is claimed is:

1. An insulator provided in a fuel cell stack, the fuel cell stack including:
a cell stack body formed by stacking a plurality of power generation cells, each including an electrolyte membrane-electrode assembly and a separator; and
a terminal plate, the insulator, and an end plate, which are provided at an end of the cell stack body in a stacking direction,
wherein the terminal plate, the insulator, and the end plate are provided in this order from a side of the cell stack body in the stacking direction, and the insulator comprises:
a main body;
a first rib standing from a first surface of the main body, the first surface facing the terminal plate; and
a second rib standing from a second surface of the main body, the second surface facing the end plate.

2. The insulator according to claim 1, wherein the first rib and the second rib are formed as a single member.

3. The insulator according to claim 1, wherein the first rib and the second rib have the same shape, as viewed from the stacking direction.

4. The insulator according to claim 2, wherein the first rib and the second rib have the same shape, as viewed from the stacking direction.

5. The insulator according to claim 1, wherein the first rib and the second rib are arranged at the same position, as viewed from the stacking direction.

6. The insulator according to claim 2, wherein the first rib and the second rib are arranged at the same position, as viewed from the stacking direction.

7. The insulator according to claim 1, wherein a third rib stands from a surface of the end plate, the surface facing the insulator, so as to abut the second rib.

8. The insulator according to claim 7, wherein the second rib and the third rib have the same shape, as viewed from the stacking direction.

9. The insulator according to claim 7, wherein the second rib and the third rib are arranged at the same position, as viewed from the stacking direction.

10. The insulator according to claim 8, wherein the second rib and the third rib are arranged at the same position, as viewed from the stacking direction.
